(19) United States
(12) Patent Application Publication
(10) Pub. No.: US 2014/0282677 A1
(43) Pub. Date: Sep. 18, 2014

(54) SECOND SCREEN APPLICATION LINKED TO MEDIA CONTENT DELIVERY

(71) Applicant: CBS Interactive Inc., San Francisco, CA (US)

(72) Inventors: Jonathan Mantell, San Francisco, CA (US); Dana Howbert, Santa Monica, CA (US)

(73) Assignee: CBS Interactive Inc., San Francisco, CA (US)

(21) Appl. No.: 14/206,235

(22) Filed: Mar. 12, 2014

Related U.S. Application Data
(60) Provisional application No. 61/777,367, filed on Mar. 12, 2013.

(51) Int. Cl. H04N 21/4722; H04N 21/4784; H04N 21/435; H04N 21/422; H04N 21/43; H04N 21/81; H04N 21/431; H04N 21/4788

(52) U.S. Cl. CPC H04N 21/4722; H04N 21/4316; H04N 21/4784; H04N 21/4788; H04N 21/42209; H04N 21/42207; H04N 21/4305; H04N 21/8173; H04N 21/435
USPC 725/23; 725/60; 725/37

(57) ABSTRACT

A system and a method are disclosed for providing for display on a screen of a secondary device augmented content to a television show displayed on a screen of a primary device. A server receives from the secondary device, information corresponding to the television show currently playing on the screen of the primary device. A synchronization cue is identified based on the information corresponding to the television show. The synchronization cue identifies a current temporal segment within the television show currently being played by the primary device. Based on the synchronization cue, augmented content is generated relevant to the current temporal segment of the television show. The augmented content enables an interactive viewer experience with the television show.

### RELATED APPLICATIONS

This application claims the benefit of U.S. Provisional Application No. 61/777,367 entitled “Second Screen Application Linked to Media Content Delivery” filed on Mar. 12, 2013 to Jonathan Mantell and Dana Howbert, the contents of which are incorporated by reference herein.

### BACKGROUND

1. Field of Art

The disclosure generally relates to the field of media content delivery.

2. Description of the Related Art

Traditional television services focused on providing broadcast content to subscribers for viewing in a passive manner. With the development of portable electronic devices such as laptop computers, tablets, and smartphones, some content providers have developed “second screen” applications that provide secondary content for viewing on the electronic devices together with the traditional broadcast content. This second screen content can include supplemental information and/or interactive applications intended to enhance the viewer's experience.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a computing environment for providing an enhanced second screen experience.

FIG. 2 illustrates one embodiment of a second screen device communicatively coupled to a second screen server.

FIG. 3 illustrates an example user interface for a second screen device.

FIG. 4 illustrates one embodiment of components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview of Second Screen Experience

A second screen device, application, and server enables an audience of primary audio/visual content (e.g., television broadcasts) to view and/or interact with supplemental content provided on a second screen device in synchronization with the primary content. Together, the primary and second screen content provides an enriched experience for viewers and opens up additional revenue sources for content providers. For example, the second screen application may provide viewers with additional information related to the content they are viewing (e.g., trivia, statistics, side notes, images, video clips, etc.) and/or may provide interactive opportunities (e.g., participating in social network feeds, voting, purchasing merchandise, etc.). In some embodiments, second screen content may be an integral part of the script and/or cinematic production, thereby providing producers with additional creative opportunities and providing a more entertaining overall experience for the audience.

It is noted that as described herein, second screen includes at least one additional electronic device configured to show content that augments the content shown on a primary (or first) screen. The primary screen comprises an electronic device in which a primary or a main broadcast is shown. For example, the primary screen shows a television show (e.g., CIS) and one or more second screens show augmented content (such as character background) corresponding to a particular scene within the show. Additional examples are provided below.

The second screen application includes numerous benefits. For example, the second screen application provides significant revenue opportunities for content providers. In addition to increasing overall viewership, the incorporation of second screen content can result in a more engaged audience. This enables advertisers to better capitalize on advertising opportunities, thereby increasing revenue sources for content providers. Additionally, use of second screen applications may help content providers avoid losing viewers of their broadcasts due to illegally copied and distributed (e.g., “pirated”) versions. For example, in some situations, television content providers may enable an associated second screen application only during “live” scheduled broadcasts of content. Thus, viewers who instead choose to watch unauthorized versions of the broadcast (e.g., pirated online versions) will lack the full experience enabled through the second screen application.

FIG. 1 illustrates an example embodiment of a computing environment for providing an enhanced second screen experience to viewers of television broadcasts or other media content. In one embodiment, the computing environment comprises a primary display device 102 outputting primary content 104 (e.g., audio/visual content), and a second screen device 106 coupled to a second screen server 110 via a network 108. The primary display device 102 comprises a television, PC, or other electronic device that receives, processes, and outputs the primary content 104 from sources such as, for example, cable television broadcasts, over-the-air broadcasts, web-based streams, or content from connected video servers or players (e.g., DVD players, blu-ray players, solid-state players, digital video recorder (DVR) devices, etc.). The primary content 104 may comprises, for example, a television show, a movie, sports event, news broadcast, etc. that may be played live as it is received by the primary display device 102, or may be played from a previous recording using, for example, a DVR.

The second screen device 106 comprises an electronic device for executing a second screen application that provides supplemental media content in the form of, for example, a visual display, an audio output, and/or haptic feedback. For example, the second screen device 106 may comprises a laptop or desktop computer, a smartphone, or a tablet device. The second screen device 106 communicates with a network 108 via a wired or wireless connection (e.g., a WiFi network or a cellular network). The second screen server 110 communicates with the second screen device 106 via the network 108 to receive user inputs and other data from the second screen device 106 and provide the supplemental content for a second screen application executing on the second screen device 106. The computing environment of FIG. 1 enables a variety of scenarios to enrich the experience of viewers of the primary content 104, examples of which are discussed below.

### Example Use Case Scenarios

### Award Show Example Use Case

In one embodiment, the second screen device 106 provides synchronized second screen content relevant to an award show being viewed on the primary display device 102. As the award show is playing, the second screen device 106 remains synchronized with the primary device 102 to provide secondary content with appropriate timing. During the award show, users of second screen devices 106 may be presented with supplemental information and interactive opportunities related to the award show. For example, during presentation of a movie award for “best picture” the second screen device 106 may provide information about for example, the cast of the winning movie, video clips from the movie, reviews of the movie, “behind the scenes” footage or images, links to purchase a copy of the movie or merchandise associated with the movie, social networking feeds showing reactions to the selection, etc. During a pre-show “red carpet” event, the second screen device 106 may present information about what different celebrity participants are wearing, footage or information related to pre-award show parties, user polls with predicted outcomes, etc.

The second screen device 106 may also enable user participation in the award show. For example, users may be able to cast votes on their second screen device 106 which are aggregated by the second screen server 110 in order to select a “fan favorite” award winner. Second screen device users may also be able to interact with each other during viewing of the show. For example, the second screen device 106 may provide a chat interface and/or social networking feeds where users can discuss a particular award or other aspect of the show while it is being viewed.

### Drama Example Use Case

In another example use case scenario, a second screen device 106 provides supplemental content relating to a television drama series such as a crime investigation show. In addition to tangential information about the show (e.g., information about cast, etc.), the second screen device 106 provides content that is weaved into the plot of the show. For example, crime scene clues (e.g., the murder knife) discovered during the show may be presented on the second screen device 106 for closer investigation by the user (e.g., as a three-dimensional rotatable image). Furthermore, the second screen device 106 may be utilized to simulate a forensic analysis of various evidence or other objects important to the plot of the show. The second screen device 106 may present police files to the user for closer inspection as they are concurrently being reviewed by characters of the show. The user may then use the second screen content to attempt to solve the mystery prior to, or together with, the characters on the show. Thus, second screen content may be used to enhance the plot and immerse the viewers more deeply and interactively with the broadcast.

In other embodiments, the second screen device 106 may be used to provide images and/or video from the perspective of a secondary character different from the perspective followed on the primary display 102. For example, in a murder investigation, the primary display 102 may tell the story from the perspective of the investigators, while the second screen device 106 provides short clips, images, or other content from the perspective of the murderer. Additionally, user interactions with the second screen device 106 during the show could affect the storyline. For example, users may vote as to how a particular character should act in a particular situation, and this decision may lead to the content servers selecting between two or more pre-recorded alternative endings.

In one embodiment, user interactions with the second screen content can be tracked and users can be awarded real or virtual rewards for their participation. For example, a user who consistently views the drama show and interacts with the second screen content may be awarded a title of “ultimate fan.” Users may also gain virtual points through their interactions that could be used, for example, to gain access to exclusive content (images, video clips, etc.) or obtain show-related merchandise.

### Live Sports Event Example Use Case

A live sports event provides additional opportunities to provide second screen content on a second screen device 106 to enhance the viewer's experience. For example, during a baseball game, the second screen device 106 may provide statistics for the current hitter and pitcher, play-by-play information, box score, out of town scoreboard, etc. The second screen device 106 may further provide video highlights from earlier in the game or from other games around the league.

In one embodiment, the second screen device 106 provides the supplemental information in synchronization with audio and/or visual cues from the primary device 102, such that this information remains synchronized even when the event is pre-recorded (e.g., not being watched live). This ensures that the viewer gets the same experience as a live viewer.

The second screen device 106 could furthermore be used to show slow motion replays of game action. In traditional sports broadcasts, display of such statistical information, highlights, involved the broadcast momentarily cutting away from the live action. However, by utilizing the second screen device 106 to provide such content, the primary display device 102 can continuously provide live action, while users are still able to experience the extra content via the second screen device 106.

In another embodiment, the second screen device 106 could provide supplemental audio and/or video relevant to the live sports event. For example, during a football game, a panel of sportscasters, fantasy football experts, players, journalists, celebrities, comedians, etc. may be assembled to comment on the game. The second screen user feels like he/she is virtually in the room with the panel. Furthermore, in one embodiment, the second screen user may participate in the conversation via a chat log, social networking feeds, etc.

### Reality Show Example Use Case

In another example use case scenario, a second screen device 106 provides supplemental content relating to a reality television series. Such television shows often involve capturing tens or hundreds of hours of video for each 30 minute or one hour episode. Thus, to provide a more in-depth viewer experience, portions of this unused footage may be provided for viewing on the second screen device 106 in a manner synchronized with the broadcasted episode. For example, if the primary content portrays a particular event from a primary camera angle, the second screen device 106 may concurrently show the same event captured from one or more different camera angles. Furthermore, the second screen device 106 may offer opportunities to view footage of related events that may have been cut out of the episode based on time constraints. For example, in a race or competition-based reality show, the primary content 104 may feature one of the teams while the second screen device 106 may be used to show concurrent progress of one or more other teams.

In other embodiments, the second screen device 106 may enable viewers to interact with the cast of the reality show or their surroundings. For example, viewers could be allowed to vote on whether a cast member should be eliminated from the show. During a live reality show, viewers could propose and/or vote on having a certain event occur (e.g., set the sprinklers off in the house) that would affect the outcome of the show and result in a more interactive experience for the audience.

### Advertising Example Use Case

In other embodiments, the second screen device 106 can be utilized as an advertising platform that provides additional revenue opportunities for content providers. For example, during traditional television commercials, the second screen device 106 may provide links to purchase the product being advertised, coupons or other incentives, information about related products, etc. These advertisements/incentives may be selected based on both the primary content and user profile information of individual users in order to serve advertisements that are likely to be of particular relevance to different users.

In other embodiments, the second screen device 106 can provide links, advertisements, or incentives concurrently with scenes of a television show or movie. For example, if a particular type of car appears in a scene, the second screen device 106 may provide links to learn more about that car, find local dealers, purchase accessories, etc. If a scene of a television show or movie takes place at a particular location (e.g., Hawaii), the second screen device 106 may present advertisements or coupons related to vacation packages, flights, hotels, restaurants, entertainment, etc. associated with that location as it is concurrently shown on the primary display device 102. Because these advertisements will be highly relevant to what the user is currently viewing, such advertisement opportunities could be sold at a premium by broadcasters or content providers, thereby providing significant sources of additional revenue.

### Example System Architecture

FIG. 2 illustrates a functional block diagram of a second screen device 106 in communication with a second screen server 110. The functional blocks (or “modules”) may be embodied as computer program instructions stored to a non-transitory computer-readable storage medium, which are loaded and executed by one or more processors to carry out the described functions. In alternative embodiments, the second screen device 106 and second screen server 110 may include different or additional functional blocks or functionality described herein may be distributed differently between the blocks. Furthermore, in alternative embodiments, functions or processes described as being performed by the second screen device 106 may instead be performed by the server 110 or vice versa.

Only one second screen server 110 and one second screen device 106 is illustrated in FIG. 2 for clarity of description. In practice, a second screen server 110 may communicate with thousands or millions of second screen devices 106. Furthermore, in some embodiments, a second screen device 106 may communicate with two or more second screen servers 110. In some embodiments, different components of the second screen server 110 are distributed between multiple servers.

In one embodiment, the second screen device 106 comprises a synchronization module 202, a server communication module 204, and a user interface module 206. The synchronization module 202 generates synchronization data to synchronize the second screen content provided by the second screen device 106 with the primary content 104 being outputted by the primary display device 102. In one embodiment, the synchronization module 202 detects and analyzes particular features of the primary content 104 (e.g., by capturing audio data via a microphone and/or capturing visual data via a camera) and uses these features to identify the primary content 104 (e.g., what is being played by the primary display 102) and timing information of the primary content 104 (e.g., a temporal location in the primary content 104). For example, the synchronization module 202 may identify a particular television show being viewed on the primary display 102 and may continuously or periodically track how far along the viewer is in the show.

A variety of different techniques may be used to identify and track the primary content 104 to generate the synchronization data. In one embodiment, the synchronization module 202 may rely on a “watermark” or other audio/visual cues that are embedded in the primary content 104 for the purpose of synchronization. For example, a video stream may have a periodic audio cue (e.g., every 5 seconds) that identifies the current playback position in the video stream. Such audio cues may be designed such that they are detectable by the synchronization module 202 but are not perceivable by humans so that they do not distract from the viewing experience. In another embodiment, a digital fingerprinting technique is used in which the synchronization module 202 periodically captures audio samples of the primary content 104 and generates a fingerprint representing the content, which can be compared against a fingerprint index for the primary content 104. In alternative embodiment, visual watermarks or appearance-based fingerprints can be used to generate the synchronization data by capturing visual features of the primary content 104 via a camera of the second screen device 106. In other alternative embodiment, more simplistic synchronization schemes can be used. For example, for television broadcasts, the synchronization engine may simply generate synchronization data based on known scheduling information without monitoring the actual primary content 104.

By continuously maintaining synchronization with the primary display device 102, the second device 106 can provide synchronized content relevant to the primary content 104 based on the synchronization data. This enables the second screen device 106 to maintain synchronization with the primary content 104 even when the content is pre-recorded or when the viewer pauses, rewinds, or fast-forwards playback.

The user interface 206 comprises various visual components and controls for providing the second screen content and for enabling user interactions with the content. For example, the user interface may comprise various windows and/or tabs for accessing various aspects of the second screen content. Furthermore, the user interface 206 may comprise various digital input controls (e.g., buttons, links, keypads, slider controls, etc.) for enabling user interactions with the second screen content.

In addition to the content itself, the user interface 206 may provide visual and/or audio synchronization queues to inform the user when additional content is available for viewing. For example, when the viewer reaches a particular moment in the primary content (as detected via the synchronization module 202), the user interface 206 may provide an alert (either on the primary device 102, the second screen device 106, or both) that second screen content is available for viewing in association with that portion of the primary content. An example embodiment of a user interface is described in further detail below with respect to FIG. 3.

The server communication module 204 facilitates communication between the second screen device 106 and the second screen server 110. The server communication module 204 receives synchronization data from the synchronization module 202 and receives control inputs from the user interface 206, and provides this data to the second screen server 110. Furthermore, the server communication module 204 receives content from the second screen server 110 for providing to the user via the user interface 206 of the second screen device 106.

An embodiment of the second screen server 110 comprises a second screen communication module 212, a user profile engine 214, a commerce application program interface (API) 216, a rewards engine 218, a metadata engine 220, and a web content engine 220. Other embodiments may include fewer, different, or additional modules. The functional blocks may be embodied as computer program instruction stored to a non-transitory computer-readable storage medium, which are loaded and executed by one or more processors to carry out the described functions. Furthermore, functions described below as being performed by the server 110 may in some embodiments instead be performed locally by the second screen device 106.

The second screen communication module 212 provides an interface to the second screen device 106 for communication to and from the various functional blocks of the second screen server 110. For example, the second screen communication module 212 may receive control inputs from a user interface 206 (e.g., requesting content) and facilitate providing the appropriate content to the second screen device 106. Furthermore, the second screen communication module 212 may receive synchronization data generated by the synchronization module 202 in order to determine what content to provide to the second screen device 106 and when to provide it. The second screen communication module 212 interacts with a number of other functional modules to provide various second screen content to the second screen device 106 as will be described below.

The user profile engine 214 stores user profile information for users of second screen devices (e.g., device 106) in communication with the second screen server 110. The user profile information may include, for example, preferences of the user (e.g., favorite television shows, favorite movies, favorite sports teams, favorite actors/actresses, etc.) useful for determining what type of content to provide the user; settings information (e.g., appearance and/or function settings for configuring the user interface 206 and/or for determining what type of content to provide and how to present it); historical information (e.g., past content viewed by the user, items purchased by the user, etc.); account information (e.g., account login and password, security settings, etc.); or other information associated with various users of the second screen devices 106.

The metadata engine 220 stores and/or generates metadata related to the primary content 104 in order to determine appropriate content to present on the second screen device 106. For example, in one embodiment, the metadata engine stores a collection of metadata indexed based on different time locations within a video (e.g., a television show or movie). Other metadata may pertain more generally to the content as a whole (e.g., an entire television show or movie) and is not necessarily correlated to one time-localized segment of the content. The metadata may include, for example, title information, cast information, episode guides, statistical information (e.g., for sports events), information about objects depicted in a particular scene, trivia or interesting facts about a show or scene, transcript information, etc. At different points in the primary content, the metadata engine 220 may look up various metadata and process the information to provide second screen content in a manner synchronized with the primary content 104 from the primary display 102.

The commerce API 216 interfaces with external e-commerce web sites 232 to provide, for example, targeted advertisements and/or purchasing opportunities as part of the second screen content. For example, the commerce API 216 may provide links to purchase merchandise associated with a television show, movie, etc. In one embodiment, the commerce API 216 may utilize metadata from the metadata engine 220 in order to determine relevant commerce opportunities. For example, when a television show depicts a particular location, the commerce API may determine offers for vacations to that location (e.g., flights, hotels, attractions, etc.) to be presented on the second screen device 106. If a particular item is shown in a scene, the commerce API 216 may generate offers related to purchasing that item. The commerce API 216 may also use information from the user's user profile in order to determine commerce opportunities that are particularly relevant to that user at relevant moments in the presentation of the primary content 104. The commerce API 216 may also provide a portal to external commerce websites 232 to enable a user to make purchases when he/she sees an offer of interest.

The web content engine 220 interacts with external web content 234 to provide relevant content to the second screen device 106 based on, for example, metadata, user profile information, and the synchronization data identifying the primary content 104 currently being viewed. For example, while watching a television show, a user may wish to find out more information about a particular actor. When the actor makes an appearance, the user interface 206 displays a control button or link allowing the user to find out more information about the actor. If the link is selected, the web content engine 222 may retrieve information from, for example, a web page associated with the actor and provide this as part of the second screen content.

The web content engine 222 may also obtain information from various social networking web sites. For example, the web content engine 222 may provides social networking posts related to the primary content so that users can see what other users are saying about it.

The rewards engine 218 generates and/or stores rewards information that can be provided as part of the second screen content. For example, in order to encourage viewers to watch a particular television show, the rewards engine may track an enrolled user's viewings and/or interactions with second screen content, and provide rewards based on the number or frequency of these views and interactions. The rewards may include, for example, access to exclusive content related to the show, merchandise, etc. Tracking usage and providing usage-based rewards encourages viewership and participation with the second screen content, thereby increasing revenue opportunities for content providers.

### Example User Interface

FIG. 3 illustrates an example embodiment of a user interface 300 for a second screen device 106. A title bar 306 provides title and scheduling information pertaining to a particular television show. A main content window 316 provides second screen content (e.g., video clips or images) that is presented for viewing in synchronization with the primary content. Summary information 304 provides information about the episode being viewed, (e.g., title, length, original air date, and synopsis). Advertising area 302 presents an advertisement that may be selected by the second screen server 110 as being related to one or more of the primary content, the secondary content, user profile information, or other metadata. The advertising area 302 may comprises a clickable link that when selected provides additional content (e.g., a website for the advertised product, incentives or coupons, links to purchase the advertised product, product reviews, etc.).

Sharing buttons 316 provide controls enabling a user to share aspects of the second screen content via social networking applications such as FACEBOOK, TWITTER, GOOGLE+, etc. Button 312 when selected provides an interface enabling the user to purchase the episode and/or other episode-related merchandise (e.g., via an e-commerce website). Comment area 310 provides social networking content related to the primary content. For example, content area 310 may display discussions about the primary content pulled from, for example, FACEBOOK walls, TWITTER feeds, etc. Furthermore, comment area 310 may include an integrated submission box to allow users to directly post to their social networking accounts or participate in the ongoing commentary in area 310 via the second screen application.

An on-screen keyboard 308 provides a text entry system for inputting text to the second screen application. In one embodiment, the keyboard 308 is native in the second screen device 106. Alternatively, the on-screen keyboard 308 is designed to appear similar to a native keyboard built into the operating system of the second screen device but is actually part of the second screen application. This enables the keyboard 308 to be visually integrated into the user interface 300 and provides the user interface developers with more flexibility in the appearance and operation of the keyboard 308.

Menu area 314 provides buttons for accessing different windows or tabs of the second screen interface 300. For example, a “watch” tab provides access to the main content of the second screen application as illustrated in FIG. 3. A “photos” tab may provide access to photos relevant to the primary content such as, for example, behind the scenes photos, cast-related photos, photos of particular props used in the show, etc. A “cast” tab provides access to more information about the cast such as, for example, names, birthdays, biography, interests, filmography, photos, links to further information, etc. The “social” tab provides access to additional social networking opportunities (e.g., via FACEBOOK, GOOGLE+, TWITTER, etc.).

While FIG. 3 illustrates just one example embodiment of a second screen user interface 300, many other different variations can be employed to provide any of the second screen content described above.

### Computing Machine Architecture

FIG. 4 is a block diagram illustrating components of an example machine that could be used as a second screen device 106 or a second screen server 104 to execute the processes described in FIGS. 1-3. The machine can be able to read instructions from a machine-readable medium and execute them in a processor (or controller). Specifically, FIG. 4 shows a diagrammatic representation of a machine in the example form of a computer system 400 within which instructions 424 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include graphics display unit 410 (e.g., a plasma display panel (PDP), a liquid crystal display (LCD), a projector, or a cathode ray tube (CRT)). The computer system 400 may also include alphanumeric input device 412 (e.g., a keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 402, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for a second screen application through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for providing for display on a screen of a secondary device augmented content to a television show, the television show displayed on a screen of a primary device, the method comprising:
receiving from the secondary device, information corresponding to the television show currently playing on the screen of the primary device;
identifying a synchronization cue within the television show based on the information corresponding to the television show, the synchronization cue identifying a current temporal segment within the television show currently being shown on the screen of the primary device;
generating based on the synchronization cue, augmented content for the screen of the secondary device, the augmented content relevant to the current temporal segment of the television show, the augmented content comprising an enhanced view of a scene or object from the current temporal segment of the television show, and the augmented content comprising a user interface for a user to interact with the enhanced view of the scene or object;
transmitting the augmented content to the secondary device for display within a user interface on the secondary device;
receiving from the secondary device an indication of a user interaction with the scene or object in the augmented content displayed on the screen of the secondary device;
and providing to the secondary device, in response to receiving the indication of the user interaction with the scene or object, additional content related to the scene or object in the augmented content.

2. The method of claim 1, further comprising:
responsive to receiving the indication of the user interaction, selecting between a plurality of alternative outcomes of the television show based on the user interaction; and
causing the broadcast of the television show to proceed according to the selected outcome.

3. The method of claim 1, further comprising:
identifying a product depicted in the current temporal segment of the television show;
providing a link to an e-commerce merchant offering the identified product; and
causing the secondary device to open a browser or application, responsive to receiving a user selection of the link, for conducting an e-commerce transaction with the ecommerce merchant.

4. The method of claim 3, wherein identifying the product comprises:
performing content recognition on the current temporal segment to automatically recognize the product based on image recognition of the product.

5. The method of claim 3, wherein identifying the product comprises:
receiving metadata associated with the current temporal segment of the television show, the metadata identifying products depicted in the current temporal segment; and
identifying the product based on the metadata.

6. The method of claim 1, further comprising:
identifying a user profile associated with a user of the second screen device, the user profile storing preferences of the user; and
generating second screen content based on the preferences of the user and the current temporal segment of the television show.

7. The method of claim 6, wherein the user profile stores historical information about the user; the method further comprising generating the second screen content based on the historical information.

8. The method of claim 1, further comprising:
providing for display in the user interface of the secondary device, an interactive communication window to enable a user of the secondary device to communicate with other viewers of the television show.

9. The method of claim 1, further comprising:
identifying a traditional advertisement in the current temporal segment of the television show;
providing a link to an e-commerce merchant offering a product in the identified advertisement; and
causing the secondary device to open a browser or application, responsive to receiving a user selection of the link, for conducting an e-commerce transaction with the

10. The method of claim 1, wherein the synchronization cues comprise known scheduling information associated with the primary content.

11. The method of claim 1, further comprising:
providing for display in the user interface of the secondary device, a window showing social networking content related to the primary content, the window further comprising a button allowing the user to share aspects of the second screen content through a social networking application and a submission box allowing the user to post directly to the social networking application.

12. The method of claim 1, further comprising:
tracking user interactions with the second screen content; and
awarding rewards based upon the user interactions.

13. The method of claim 1, further comprising:
providing for display in the user interface of the secondary device, an interactive communication window to enable a user of the secondary device to communicate with a host of a television show.

14. A non-transitory computer readable storage medium, the computer readable storage medium storing instructions that when executed by a processor cause the processor to perform steps including:
receiving from the secondary device, information corresponding to the television show currently playing on the screen of the primary device;
identifying a synchronization cue within the television show based on the information corresponding to the television show, the synchronization cue identifying a current temporal segment within the television show currently being shown on the screen of the primary device;
generating based on the synchronization cue, augmented content for the screen of the secondary device, the augmented content relevant to the current temporal segment of the television show, the augmented content comprising an enhanced view of a scene or object from the current temporal segment of the television show, and the augmented content comprising a user interface for a user to interact with the enhanced view of the scene or object;
transmitting the augmented content to the secondary device for display within a user interface on the secondary device;
receiving from the secondary device an indication of a user interaction with the scene or object in the augmented content displayed on the screen of the secondary device;
and providing to the secondary device, in response to receiving the indication of the user interaction with the scene or object, additional content related to the scene or object in the augmented content.

15. The non-transitory computer readable storage medium of claim 14, further storing instructions that when executed by the processor cause the processor to perform steps including:
responsive to receiving the indication of the user interaction, selecting between a plurality of alternative outcomes of the television show based on the user interaction; and
causing the broadcast of the television show to proceed according to the selected outcome.

16. The non-transitory computer readable storage medium of claim 14, further storing instructions that when executed by the processor cause the processor to perform steps including:
identifying a product depicted in the current temporal segment of the television show;
providing a link to an e-commerce merchant offering the identified product; and
causing the secondary device to open a browser or application, responsive to receiving a user selection of the link, for conducting an e-commerce transaction with the ecommerce merchant.

17. The non-transitory computer readable storage medium of claim 14, further storing instructions that when executed by the processor cause the processor to perform steps including:
identifying a user profile associated with a user of the second screen device, the user profile storing preferences of the user; and
generating second screen content based on the preferences of the user and the current temporal segment of the television show.

18. The computer readable storage medium of claim 14, the computer readable storage medium further storing instructions that when executed by a processor cause the processor to perform steps including:
providing for display in the user interface of the secondary device, an interactive communication window to enable a user of the secondary device to communicate with other viewers of the television show.

19. The non-transitory computer readable storage medium of claim 14, further storing instructions that when executed by the processor cause the processor to perform steps including:
providing for display in the user interface of the secondary device, a window showing social networking content related to the primary content, the window further comprising a button allowing the user to share aspects of the second screen content through a social networking application and a submission box allowing the user to post directly to the social networking application.

20. The non-transitory computer readable storage medium of claim 14, further storing instructions that when executed by the processor cause the processor to perform steps including:
tracking user interactions with the second screen content; and
awarding rewards based upon the user interactions.
